(19) United States
(12) Patent Application Publication
(10) Pub. No.: US 2026/0285511 A1
(43) Pub. Date: Sep. 24, 2026

(54) Airborne Robotics for Inspection of Large Geographical Sites

(71) Applicant: Dan SHARONI, San Jose, CA (US)

(72) Inventor: Dan SHARONI, San Jose, CA (US)

(21) Appl. No.: 19/200,208

(22) Filed: May 6, 2025

Related U.S. Application Data
(60) Provisional application No. 63/643,871, filed on May 7, 2024.

(51) Int. Cl. B64U 20/87; B60L 15/32; B64U 101/30; G06T 7/00; G06T 19/00; H02S 50/00

(52) U.S. Cl. CPC B64U 20/87; B60L 15/32; G06T 7/0004; G06T 19/003; H02S 50/00; B60L 2200/10; B60L 2240/54; B60L 2240/60; B64U 2101/30; B64U 2201/102; G06T 2207/10032

(57) ABSTRACT

Embodiments described herein provide a novel approach to the visual inspection and oversight of large plants and other facilities, and are especially suited to the ongoing inspection and maintenance of utility-solar plants and the like, such as windmill farms, factories, etc. Inspection is performed using coordinated groups (“fleets”) of drones or unmanned aerial vehicles (UAVs) that fly autonomously or under the control of a remote pilot or using a combination of pilot-based and autonomous controls. According to various embodiments described herein, the drones may be capable of advanced autonomous functions including collision avoidance, follow-the-leader flying, automatic landing and take-off, automatic or scheduled charging, flying in predetermined formations, and automatic imaging operations (e.g., capturing photo or video data).

### CROSS-REFERENCE TO RELATED APPLICATIONS

The present application is utility conversion and claims priority to U.S. Provisional Patent Appl. No. 63/643,871 filed May 7, 2024, naming Dan Sharoni as the Inventor, the content of which is fully incorporated by reference as if set forth fully below.

### FIELD

The present invention generally relates to the field of robotics. More specifically, embodiments of the present invention relate to autonomous airborne robotic devices useful for performing inspection activities.

### BACKGROUND

The climate crisis represents a unique opportunity for cutting edge developments of profitable and sustainable large-scale renewable energy generation and storage technology. The renewable energy industry has historically faced challenges in scaling up such projects due to limitations in planning, operational management, and maintenance efficiency. Traditional methods of developing renewable energy facilities often involved time-consuming and costly inspection of energy generation facilities usually performed manually by inspection workers, in addition to subsequent data collection and analysis which can further delay operations. A more efficient approach to the ongoing Operation and Maintenance (O&M) of these facilities is a well-known need in the art.

Solar farms employ numerous solar panels or collectors that often extend over hundreds or even thousands of acres and can present unique challenges for inspection due to rough terrain, inclement weather, and long distances that must be covered. For these reasons, it is often difficult to keep up with regular inspection of each device or solar panel to ensure high levels of performance and efficiency and discover those solar panels that may need cleaning and/or repair. For example, each panel may need to be checked to identify micro-cracks, hotspots, or shading effects that might not be visible without sophisticated tools. Additionally, power generation facilities may also pose risks, requiring specific safety protocols, training, and protective gear to protect human workers and inspectors.

To overcome these challenges and improve the efficiency of solar farms and the like, airborne robotic vehicles (drones or unmanned arial vehicles) have been employed to perform these often dangerous and time-consuming tasks. However, the existing approaches to inspection of solar farms and the like unfortunately lack the ability to scale up sufficiently to cover large-scale production facilities in an efficient manner. Furthermore, these existing approaches lack the ability to coordinate drone operations in a sophisticated manner and the drone devices utilized are typically limited in battery life (less than 60 min), further reducing their usefulness.

Beyond logistical issues, different states and counties have different standards for solar installations, maintenance, and safety, and detailed documentation of inspection and maintenance procedures may be necessary for compliance, insurance, or warranty purposes, which can be burdensome and further increases costs. Airborne robotics are also subject to additional regulations by the Federal Aviation Administration (FAA), which mandate specific certifications for drone pilots and place restrictions on flights beyond the visual line of sight of the drone pilot when operating in the United States, or for piloting multiple airborne drones at the same time. For example, FAA regulations typically allow only one drone to be controlled by a Remote Pilot In Command (RPIC), and anything else is considered to be beyond visual line of sight (BVLOS).

Accordingly, what is needed is a scalable approach to airborne robotics capable of performing efficient routine inspections of large geographical facilities having facility components spread over large areas where the inspections are done in compliance with existing regulations and procedures.

### SUMMARY OF THE INVENTION

Embodiments of the present invention provide a novel approach to the visual inspection and oversight of large geographical plants and other facilities, and are especially suited to the ongoing inspection and maintenance of utility-solar plants and the like, such as windmill farms, factories, etc. Inspection of solar panels, for instance, can be performed using coordinated and/or synchronized groups (“fleets”) of drones or unmanned aerial vehicles (UAVs) that fly autonomously or under the control of a remote pilot, or using a combination of pilot-based and autonomous controls. According to various embodiments described herein, the drones may be capable of advanced autonomous functions including automatic collision avoidance, follow-the-leader flying, automatic landing and take-off, automatic or scheduled charging, flying synchronously in predetermined formations, and automatic imaging operations (e.g., capturing photo or video data).

According to one embodiment, a robotic equipment inspection system is described, including a plurality of unmanned aerial vehicles (UAVs) including a plurality of sensors and operable to fly in coordination to capture data using the plurality of sensors and a wireless control system operable to manage coordinated flight of the plurality of UAVs via a mesh communication network providing real-time communication amongst the UAVs themselves and with a ground station. The ground station includes a memory operable to store data captured by the plurality of sensors of the plurality of UAVs and a processor operable to analyze the data captured to identify ground-based equipment suspected of requiring maintenance.

According to some embodiments, the processor is further operable to generate a 3D digital representation of the equipment for inspection and generate a flight plan for the plurality of UAVs based on the 3D digital representation.

According to some embodiments, the plurality of UAVs are capable of: automatic collision avoidance, follow-the-leader flying, automatic take-off and landing, automatic return to base for charging, and automatic image capture operations.

According to some embodiments, at least one of the plurality of UAVs is designated as a control tower UAV that provides substantially real-time video data to a RPIC via a separate wireless network, at least one of the plurality of UAVs is designated as squadron leader, and other UAVs of the plurality of UAVs fly substantially in synchronization with a flight path of the squadron leader.

According to some embodiments, the first UAV forwards sensor data to a second UAV of the plurality of UAVs, and the second UAV forwards the sensor data to the remote pilot.

According to some embodiments, the video data includes 30 frames per second video data.

According to some embodiments, the ground-based equipment includes photovoltaic (PV) panels, and the plurality of UAVs include a plurality of infrared (IR) sensors operable to detect temperature variations in the PV panels to identify potentially malfunctioning cells of the PV panels.

According to some embodiments, the data captured includes image data, the processor is further operable to analyze the image data to identify image artifacts, and the wireless control system causes the plurality of UAVs to recapture images responsive to the identifying image artifacts.

According to some embodiments, the wireless control system is operable to receive input from a remote pilot to control the plurality of UAVs in real-time.

According to some embodiments, the wireless control system is operable to control the plurality of UAVs according to a predetermined flight path and formation.

According to another embodiment, a method for inspecting ground-based equipment using airborne robotics is disclosed. The method includes deploying a plurality of unmanned aerial vehicles (UAVs) over a designated inspection area, the plurality of UAVs including a plurality of sensors, capturing image data of ground-based equipment using the plurality of sensors transmitting captured image data to a ground station via a mesh wireless communication network, processing the image data at the ground station to create a 3D digital representation of the ground-based equipment, and performing detailed imaging of the ground-based equipment according to the 3D digital representation to identify a potential defect in the ground-based equipment.

According to some embodiments, a first UAV of the plurality of UAVs is a control tower UAV, a second UAV of the plurality of UAVs is a squadron leader, other UAVs of the plurality of UAVs fly substantially in synchronization with the squadron leader, and the squadron leader and the other UAVs fly in view of a camera of the control tower UAV.

According to some embodiments, the method includes automatically analyzing results of the detailed imaging to confirm the potential defect in the ground-based equipment and generating a maintenance report including the defect of the ground-based equipment.

According to some embodiments, the method includes automatically adjusting flight paths of the UAVs based on real-time weather data.

According to some embodiments, the method includes receiving battery data from the plurality of UAVs and adjusting a flight path of the plurality of UAVs based on the battery data.

According to some embodiments, the method includes identifying an image artifact in the captured image data and recapturing images until the image data is substantially free of image artifacts.

According to a different embodiment, a ground station for coordinating unmanned arial vehicle (UAV) flight and visual inspection of ground-based equipment is disclosed. The ground station includes a wireless communication network operable to receive real-time data from a plurality of unmanned aerial vehicles (UAVs) over a mesh network, a processing module operable to generate image analysis results by analyzing the received data to identify potential defects in the ground-based equipment, a control module operable to adjust the flight paths of the UAVs based on the image analysis results via the wireless communication network, and memory operable to store the real-time data and image analysis results.

According to some embodiments, the processing module if further operable to identify image artifacts in the received data and instruct the plurality of UAVs to re-capture additional data via the wireless communication network until the additional data is sufficiently free of image artifacts.

According to some embodiments, the processing module is further operable to simulate a 3D environment based on the captured data, where a flight plan of the plurality of UAVs is simulated within the 3D environment, the flight plan is adjusted based on the simulated flight plan, and the flight plan includes at least one of a number of UAVs, a type of UAV, a UAV recharging schedule, a UAV formation, and a UAV flight altitude.

According to another embodiment, a method of imaging ground-based equipment using airborne robotics to produce a 3D model is disclosed, the method including flying a squadron of unmanned aerial vehicles (UAVs) over the ground-based equipment, where the squadron automatically flies in synchronized formation with a squadron leader UAV, capturing image data of ground-based equipment using cameras disposed on the squadron of UAVs, where the image data of respective UAVs of the squadron include overlapping image data, and generating a 3D representation of the ground-based equipment based on the overlapping image data.

According to some embodiments, the squadron leader is controlled remotely by a remote pilot in command.

According to some embodiments, the method includes flying a control tower UAV including a camera orbiting around a designated point, where the squadron of UAVs are visible to the camera of the control tower UAV to enable beyond visual line of sight (BVLOS) flight of the squadron leader by the remote pilot.

According to some embodiments, the overlapping image data includes at least 50% overlapping image data.

According to some embodiments, the overlapping image data includes at least 80% overlapping image data.

### BRIEF DESCRIPTION OF THE DRAWINGS:

The accompanying drawings, which are incorporated in and form a part of this specification and in which like numerals depict like elements, illustrate embodiments of the present disclosure and, together with the description, serve to explain the principles of the disclosure.

FIG. 1A and FIG. 1B are block diagrams depicting an exemplary visual high-level Unified Modeling Language (UML) component diagram of an operating system platform implemented using object-oriented programming for controlling and communicating with drones used for visual inspection purposes according to embodiments of the present invention.

FIG. 2 is a diagram depicting an exemplary airborne inspection system including multiple drone squadron modules in communication with a portable ground station over a wireless mesh network according to embodiments of the present invention.

FIG. 3 is a diagram depicting an Orbiting Tower UAV 3D view of an exemplary Airborne Control Tower UAV system for Beyond Visual Line of Sight (BVLOS) drone flight according to embodiments of the present invention.

FIG. 4 is a diagram showing a top-down view and a side view of a five UAVs hive inspecting a large-utility scale PV solar plant at a designated inspection area according to embodiments of the present invention.

FIG. 5 is a flowchart depicting the steps of an exemplary computer-implemented real-time AI driven Machine Learning feedback process for performing autonomous visual inspection of a large-scale facility, such as a utility-solar farm or the like in accordance with embodiments of the present invention.

FIG. 6 is a block diagram of an exemplary computer system upon which embodiments of the present invention can be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

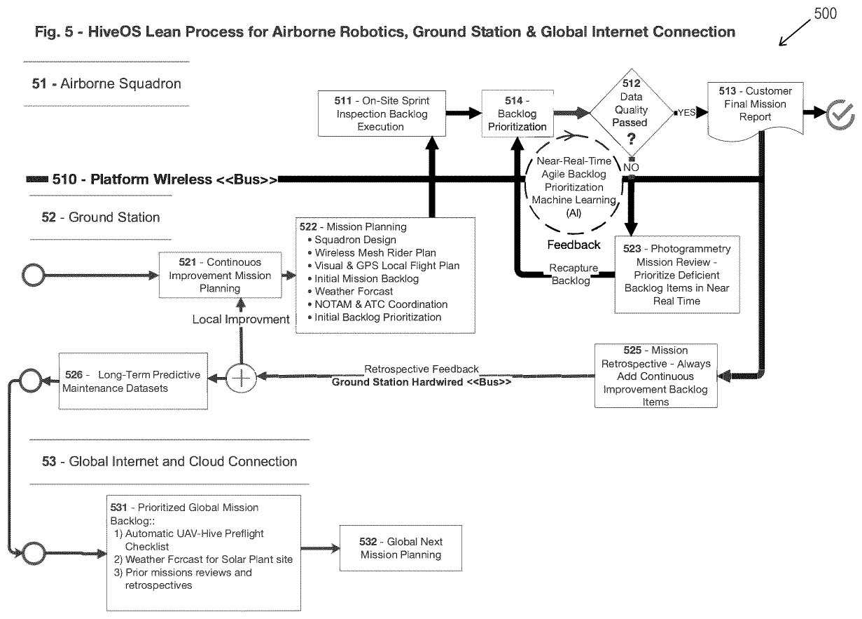

Portions of the detailed description that follow are presented and discussed in terms of a method. Although steps and sequencing thereof are disclosed in a figure herein (e.g., FIG. 5) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “displaying,” “writing,” “including,” “storing,” “rendering,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Coordinated UAV Flight for Visual Inspection of Large-Scale Facilities

Embodiments of the present invention provide a novel approach to the visual inspection and oversight of large geographical plants and other facilities, and are especially suited to the ongoing inspection and maintenance of utility-solar plants and the like, such as windmill farms, factories, etc. Inspection is typically performed using coordinated groups (“fleets” or “hives”) of drones or unmanned aerial vehicles (UAVs) that fly autonomously or under the control of a remote pilot, or using a combination of pilot-based and autonomous controls. According to various embodiments described herein, the drones may be capable of advanced autonomous functions including collision avoidance, follow-the-leader flying, automatic landing and take-off, automatic or scheduled charging, flying in predetermined formations, and automatic imaging operations (e.g., capturing photo or video data).

As described in greater detail below, a 3D digital representation of the facility under inspection (a “digital twin”) can be created from data captured by cameras or other sensors mounted on one or more drones in an initial training phase, and the digital model can be used to evaluate aspects of the plant or facility for inspection and maintenance purposes (e.g., to determine how many drones should be used for the inspection phase, how many squadrons, formations, flight time, recharging schedule, etc.). In this way, the inspection and maintenance process can be highly automated to improve efficiency and increase the scale of inspection that can be performed in a relatively short period of time, all while keeping crew members safe from potential hazards. Moreover, the plant under inspection can remain operational longer with less downtime as embodiments of the present invention improve the ability to quickly and easily recognize defects and/or degradations and identify issues that can be addressed sooner and at a lower cost.

Embodiments of the present invention address the regulatory complexities of flying airborne vehicles by advantageously providing functionality that effectively extends the visual perception of the RPIC to enable flying drones beyond what would normally be the pilots visual line of sight by natural vision. According to some embodiments, a drone can be designated as a “control tower” drone that provides real-time visual information (e.g., 30 fps video) of the drones in flight to the pilot so that the vision of the pilot is extended in order to see other drones that may be beyond the pilot's natural vision. The control tower drone can be configured to fly in a simple pattern above the drones in flight (e.g., a circle or elliptical orbit over a fixed point) that provides sufficient visibility to control dispatched fleet of drones.

Advantageously, the network communication range of the inspection operation can be extended using the drones to form a wireless mesh network that enables communication between drones such that a distant drone can use the mesh network to communicate with devices typically out of range. For example, a distant drone can use the mesh network provided by other airborne drones to communicate back to the base station or to another operator in the field that would be beyond the distant drone's capabilities by itself. Advanced mobile mesh wireless broadband technology can be employed, such as arial mesh rider radios.

To facilitate the operation and any necessary maintenance of the drones themselves, a base station may be deployed to provide charging and communication resources for the drone operations. For example, the base station can be a truck or van that includes equipment for communicating with the drones and for recharging or swapping drone batteries. The vehicle can include docking bays or boxes that allow the drones to automatically land and begin charging without any human interaction. Moreover, the vehicle can include solar panels which allow the vehicle to generate, store, and provide clean reusable power to recharge multiple drones in the field. According to some embodiments, drone batteries are swapped manually at the base station, which reduces the amount of down time between flights. According to other embodiments, drones with depleted batteries return to the base station and are replaced by other drones with charged batteries. Using these various charging and replacement techniques, the drones and their charge states can be considered a virtual or distributed battery, the charge of which can be increased or depleted as desired to accommodate the mission goal of a particular site.

A “distributed battery” in a UAV fleet means the fleet's total energy is managed collectively, allowing missions to be planned by adding enough drones so that all deplete their batteries evenly, ensuring they complete the mission and enter landing procedure simultaneously with just enough power remaining to land. If conditions change, such as high winds increasing energy consumption, replacement drones can be deployed mid-mission to sustain operations. This dynamic power-sharing and drone-swapping approach maximizes efficiency, extends mission range, and ensures continuous operation without unplanned downtime.

Using such a system, as described above, drones can fly coordinated patterns across a large scale solar panel array and record images of the solar panels for subsequent analysis to determine panel damage or degradations of performance. Such inspection techniques are extremely efficient and safe.

According to some embodiments, a UAV-Hive can inspect a wind turbine while the turbine blade is generating energy by using mesh wireless module installed on the turbine to synchronize drone movements. While the turbine's blades are constantly spinning, the drones can fly in synchronization with the blades to avoid collisions and capture accurate inspection data. The mesh network on the turbine acts as a local communication hub, sending real-time blade position data to the UAVs. The drones use this data to adjust their flight paths, keeping a safe distance while following the movement of the blades. The fleet works together, sharing positioning and inspection data through the mesh network to ensure full turbine coverage without interfering with each other. This allows the UAV-Hive to inspect critical turbine components—blades, nacelle, and tower without shutting down power generation, increasing efficiency and minimizing downtime.

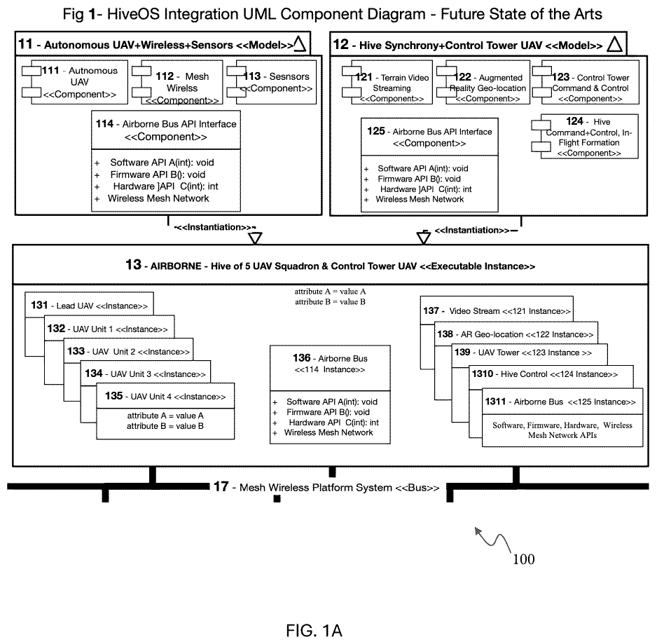

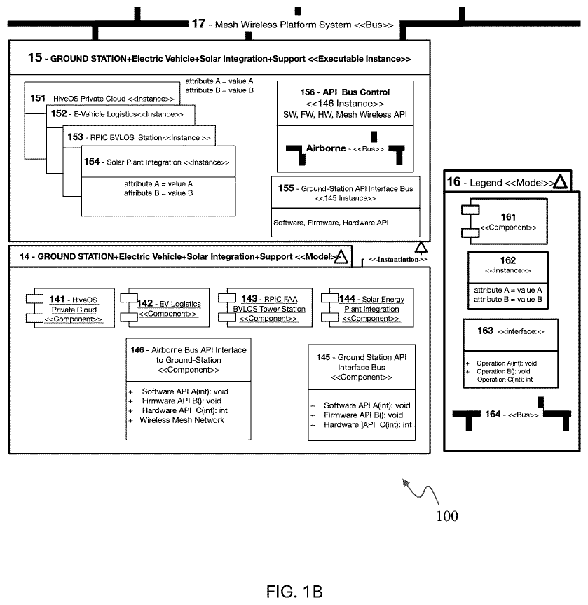

FIGS. 1A and 1B are block diagrams depicting exemplary high-level components of an operating system platform 100 implemented using object-oriented programming for controlling and communicating with drones used for visual inspection purposes according to embodiments of the present invention. In this embodiment, as depicted in Legend 16, there are 4 types of objects that a model can contain: Component 161, Instance 162, Interface 163, and/or Bus 164. A model must be instantiated to be executable, inheriting some or all properties of an instantiable Component, Instance, Interface, or Bus. An executed Instance communicates with other Instances via the Bus.

As shown in FIG. 1A, Autonomous UAV Model 11 with wireless and sensors defines Autonomous UAV Component 111 connected via mesh Wireless Network Component 112 and equipped with Sensors Component 113. UAV Model 11 also defines the Airborne Bus API 114, and the software, firmware, hardware, and mesh Wireless API interfaces for UAV Model 11. Importantly, the Interface is the only module that needs to be modified to accommodate any future upgraded or improved UAV Component. This is beneficial as UAV technology will be repeatedly improved over the next decades. Therefore, the adaptability and scalability of any inspection platform depends on innovations using the Interface. In the example of FIG. 1A, Platform Systems Bus module 17 is used as the common communications network within and between Model Airborne Instance 13 and Ground Station Instance 15 for all component modules, and can accommodate new UAV components as technology evolves.

According to some embodiments, any component of the system can be upgraded including Mesh wireless modules etc., and the changes necessary to integrate the upgrades are limited to a thin layer called Veneer, in one embodiment, which refers to relatively simple and inexpensive software. The hardware changes to the Bus can include the mesh wireless network for the airborne objects and some of the ground objects, while other devices or components may interface directly using a wired connection.

Hive Synchrony and Control Tower UAV Model 12 includes Terrain Video Streaming Component 121, Augmented Reality (AR) Geo Locations Component 122, Control Tower UAV Command and Control Component 123, Command and Control for Hive in-flight Formation Component 124, and Airborne Bus API Interface 125, including Software, Firmware, Hardware, and Mesh Wireless APIs.

Exemplary Airborne Hive of 5 UAVs and Control Tower UAV 13 represents a squadron of UAVs and includes instances for Lead UAV (131), UAV Unit 1 (132), UAV Unit 2 (133), UAV Unit 3 (134), and UAV Unit 4 (135), and all methods, attributes, parameters and other functionalities are inherited from Model 11. Instance 13 represents the Airborne executable instances of five UAVs in-flight formation as a hive, streaming visual and/or thermal sensor mapping images to the ground station, although additional or fewer drones can be used.

Control Tower UAV model 12 streams video of other drones in flight from a higher altitude and generates six UAV flight telemetry meta data to be wirelessly transmitted via the 17-Platform System Bus to the Ground Station Instance 15. Instance 13 further includes Airborne Bus API Interface Instance 136 which is instantiated from Airborne Bus API Interface 125 of Model 12 and Airborne Bus API Interface 114 of Model 11. API Bus Control Bus Interface 1311 includes hardware radio information for implementing the mesh network. Instance 13 also includes Terrain Video Streaming Instance 137, Augmented Reality Geo-location Instance 138, UAV Tower Command and Control Instance 139, UAV Hive squadron Command & Control Instance 1310, which are instantiations of attributes, methods and functionalities from components 121, 122,123 and 124 of Model 12.

Ground Station 14 Model component 143 provides support for UAVs of Model 12, including imaging, charging, and logistical support to enable BVLOS flight. As depicted in FIG. 1B, Ground Station Instance 15 is the executable instantiations of HiveOS Private Cloud 151, including EV Portability Logistics instance 152, RPIC BVLOS Ground-Station instance 153, and Utility-Solar PV Plant Integration 154, and attributes, properties, methods and functionalities, defined in Model 14. Model 14 includes HiveOS Private Cloud Access Component 141, EV Logistics Component 142, RPIC FAA BVLOS Tower Station Component 143, Solar Energy Plant Integration Component 144, Ground Station API Interface Bus Component 145, Airborne Bus API Interface to Ground-Station Component 146, which are instantiated in Ground Station 15 as executables 151-156.

As shown in both FIGS. 1A and 1B, Platform System Bus 17 is the Mesh Wireless network interface for the entire platform as deployed and supports functions such as PV plant 3D/2D imaging, UAVs geo-location telemetry data, mission arena context awareness in high resolution (e.g., 4K video) with air-traffic separation, and augmented reality symbology that can be rendered in real-time, among functions, which can be instantiated in Instance 15 as executables.

According to some embodiments, the API interface units mentioned above (e.g., Interface units 114, 125, 136, 1311, 145, 146, 155, and 156) are equipped with a hardware module with embedded firmware that provides a programmable layer for specific hardware functions, such as cameras, sensors, or UAV actuators. Some of the modules (e.g., modules 1311, 156, and/or 145) also contain hardware interfaces and firmware to manage mesh wireless radios, facilitating robust networking capabilities. These radios enable communications of Airborne UAV-to-Airborne UAV, Airborne UAV-to-Ground Station, and/or Ground Station-to-Ground Station, ensuring seamless messaging from any module to any other and at any time, across the system. Messaging can involve any data type, such as protocols, images, video streaming, telemetry data, command & control etc.

Providing modular API interface units in this way allows UAV systems to seamlessly integrate new UAV brands and models, facilitating upgrades without extensive system redesign. This is particularly true with respect to the accelerated evolution of UAV technology in the next two decades. For instance, when upgrading to a new UAV brand or model, Interface Model 114 can be quickly adapted to interface with the new unit's specific hardware and communication protocols without requiring any other significant modifications to the system. Conveniently, this functionality ensures that even as UAV technologies advance, the system remains capable of incorporating these new innovations and improvements. This adaptability not only extends the operational capabilities of UAVs but also maximizes investment by reducing the need for complete system replacements as technology evolves. Moreover, as described in more detail below, some embodiments of the present invention can instantiate the entire system as flight simulation for testing and tuning of UAVs and their various configurations to determine suitability for specific tasks, such as flying in specific weather conditions or using specific battery technology (e.g., charging methodologies). This aspect of the present invention further reduces the complexity of integrating new innovations and improvements into the system, as the new designs and configurations can be verified using software before they are physically committed to hardware and then deployed in the real world.

Another benefit of the streamlined UAV feedback loop is the ability to test image quality from the UAV camera in real-time at the ground station, leveraging the HiveOS high performance computer and photogrammetry software. All low-quality images can be queued, recaptured and tested to maximize quality before mission completion. More details regarding the UAV feedback loop and recapture process are described below with respect to FIG. 5.

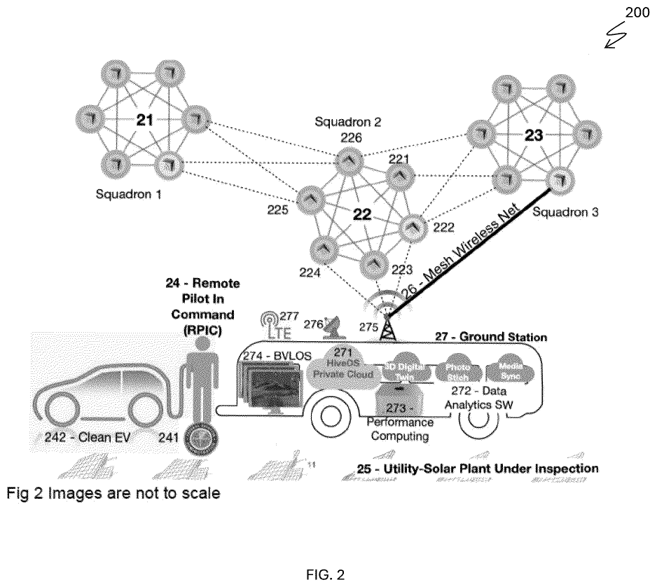

FIG. 2 is a diagram depicting an exemplary airborne inspection system 200 including drone squadrons modules 21, 22, 23 in communication with ground station 27 over a wireless mesh network 26 according to embodiments of the present invention. The ground station 27 may be implemented using a clean-air electric vehicle (EV) 242 that can include charging means such as solar panels or rechargeable batteries, for example. The squadron modules 21, 22, 23 are drones piloted remotely by the RPIC 24 to perform large-scale imaging and inspection operations of the utility-solar plant under inspection 25. The portable embodiment depicted in FIG. 2 advantageously enables an entire inspection mission to complete at near real-time flight speeds over 20 mph, and the same drones with freshly pre-charged batteries can be immediately dispatched to the next mission location.

Importantly, system 200 depicted in FIG. 2 is a self-sustained system that includes all necessary technologies, energy, computing, networking and telecommunications resources necessary to complete inspection missions. The flight path of a single squadron or multiple squadrons of autonomous UAVs are synchronized for tight in-flight formation to provide significantly larger photogrammetry inspection footprint and data redundancy. Data is transmitted and received by drones over High bandwidth mesh wireless network 26 that can expand to accommodate a large number of network nodes for expandable range sufficient to cover large-scale utility-solar photo voltaic plants.

Data from squadron modules 21, 22, and 23 can be communicated to portable ground station 27 containing high performance computer equipment (e.g., data processing servers), photogrammetry software running in close feedback loop in real time, and cumulative continuous improvement feedback and HiveOS private cloud on-site. For example, according to some embodiments, HiveOS Private Cloud Module 271 executes HiveOS SW to provide private cloud access in real time, and Data Analytics Module 272 provides a local feedback loop to enable continuous improvement of digital twins, 3D scanning and 2D mapping software. Ground station 27 is towed by EV 242 where the RPIC 24 is the top operational authority holding FAA BVLOS certificate 241.

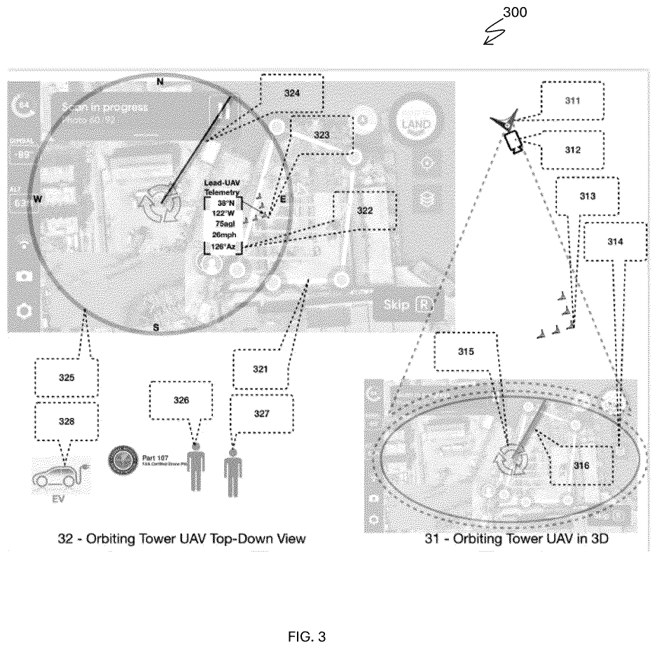

The FAA certified beyond visual line of sight (BVLOS) waiver capability enables visually monitoring of the entire operational airspace to empower one RPIC (and optional flight observer) to operationally and legally fly multiple UAV-Hives. Video streaming to ground station 27 from the UAV Control Tower (see FIG. 3 Module 311 and Module 312) orbiting a fixed, clearly visible ground point and provides air traffic-display, superimposed with Augmented-Reality symbology indicating telemetry data of all UAV-Hive(s). Cell tower LTE/5G 277 and satellite antennas 276 are not utilized for near real-time operations as they impose higher latency and may expose the inspection mission to cyber security risks, but can optionally be included as emergency communications, or as external channel while the inspection mission is NOT actively on-air.

In the example of FIG. 2, Squadron (UAV-Hive) Module 22 consists of UAV-Lead module 226 and 5 additional synchronized UAV modules 221, 222, 223, 224 and 225. Squadron 1 & 3 (modules 21 and 23) are similarly synchronized around their UAV-Leads, as well. The 18 UAVs of system 200 share command & control signals and telemetry data via Mesh Wireless Network Module 26 also shown as ALL interconnecting dotted lines amongst all drones.

All UAVs include visual cameras for performing inspection of the solar panels and other components of plant 25. Thermography and other sensors perform the 3D surveying and mapping operations. The command & control signals are generated within Ground Station Module 27 and wirelessly transmitted via Main Mesh Wireless Antenna Module 275, which can be implemented using a combination of wireless communication standards like IEEE 802.11ax protocol and mesh networking protocols such as Ad-hoc On-Demand Distance Vector (AODV) and Optimized Link State Routing (OLSR) protocols, as well as, other self-healing and self-organizing capabilities that allow the network to adapt dynamically to changes. According to some embodiments, the drones include two or more cameras, one dedicated to capturing images and the other camera dedicated to capturing video (e.g., 30, 60 or higher FPS video). According to other embodiments, some drones include a camera only for capturing images, and other drones (e.g., control tower drones) include a camera only for capturing video, which can be transmitted to Ground Station Module 27.

Each node in the network can be equipped with hardware components like a wireless transmitter/receiver and a processor to manage data routing. The network can be managed using network management software, which provides tools for configuration, monitoring, and troubleshooting. Together, these technologies and techniques ensure that the mesh network is flexible, scalable, resilient, and capable of providing reliable wireless seamless connectivity over a large area where data is dynamically and autonomously routed through the most efficient path. Modules 275 is the radio antenna for the Mesh Wireless network, 276 is for satellite communication and 277 is for cellular communication.

According to some embodiments, IR sensing of PV panels can be performed by one or more drones without interfering the PV panels energy production from sunlight. The sensors can capture temperature data that can provide detailed information about the individual energy generating cells. In most cases the entire PV panel is a structure of light sensitive diodes, and their respective temperatures are visible to the thermography sensor. For example, damaged diodes (e.g., shorted or otherwise) may be hotter than surrounding diodes, and therefore these temperature differences are easily identifiable on a diode-by-diode basis. Often a single damaged diode may damage neighboring diodes and the temperature information of the diodes can be the input to a predictive maintenance algorithms to identify damaged cells or panels having degraded performance that may require cleaning, repair, or whole panel replacement.

The reliability of system 200 is substantially improved by the wireless mesh network topology as each drone can communicate with multiple other drones, creating multiple paths for data transmission. Moreover, mesh networks 26 can dynamically adjust to changes. For example, as drones move, the network can be automatically reconfigured to maintain a high degree of connectivity. Adding more drones to mesh network 26 is simple and efficient, as each new drone can seamlessly and automatically contribute to the mesh which facilities scaling. Advantageously, system 200 can communicate over mesh network 26 in a way that distributes the data load across multiple drones to balance loads and communicate over efficient channels.

As mentioned above, telemetry from airborne UAVs is received by ground station 27, providing geolocation required for the drone path synchronization algorithms. The command & control signals keep the 3 UAV Leaders and their respective squadron UAVs flying the planned mission. Graphical lines and dotted lines in the figure connecting the UAVs and the ground station symbolize the mesh network where most nodes are connected to most other nodes to enable the wireless mesh network functionality.

Module 24 designates the RPIC, certified under FAA Part 107. According to FAA regulation, “no person shall operate a drone Beyond Visual Line of Sight (BVLOS),” and “no person shall operate more than one unmanned aircraft at a time” unless specifically authorized by waiver. To enable BVLOS operations, the RPIC must obtain a Part 107.31 waiver from the FAA, demonstrating that the proposed operation can be conducted safely and provides an equivalent level of safety to standard VLOS operations. Module 241 represents the required BVLOS waiver certificate issued to the RPIC by the FAA, legally authorizing that individual to serve as the Principal Operator for missions that exceed standard Part 107 limits. A Visual Observer (VO) may be optionally assigned to assist in maintaining situational awareness and must report directly to the RPIC, in accordance with 14 CFR § 107.33.

In summary, Clean Electric Vehicle Module 242 provides portability and the trailer Module 27—Ground Station provides expandability to include Module 274 BVLOS control tower visual display functionalities, in the form of a plurality of display devices. Module 274 can display video streaming at the ground station 27 from the Control Tower UAV and/or the other UAVs in flight. The telemetry data can be overlayed using augmented reality over the real-time video stream to show formation, geolocation, flight dynamics, GPS values and the like.

According to some embodiments, the visual data 274 rendered at the ground station 27 (e.g., by computer system 273) includes real-time UAV-Hive positions, flight data, and surrounding traffic, ensuring compliance with FAA see-and-avoid regulations. The video feed can overlay real-time GPS location, speed, and direction of each Lead UAV, giving the RPIC full awareness of fleet positioning. If connected to Air Traffic Control (ATC) communications or ADS-B data, the AR overlay can show manned aircraft positions, allowing immediate risk assessment. If a conflict is detected, the system can generate automated alerts and provide the option for immediate landing or re-routing commands to prevent violations or even collisions. Combining control tower UAV feeds with AR enhances BVLOS safety by maintaining a high level of airspace awareness and separation. By integrating AR with mesh networks, telemetry, and ATC data, UAV-Hive fleets can operate BVLOS safely and efficiently, ensuring full compliance with FAA waiver requirements.

According to some embodiments, Module 274 is designed specifically based on the overall mission objectives and to include all safety measures required by FAA regulations, to secure the people involved and bystanders, other remote or manned aircraft sharing the same airspace and the operations and the properties in the vicinity.

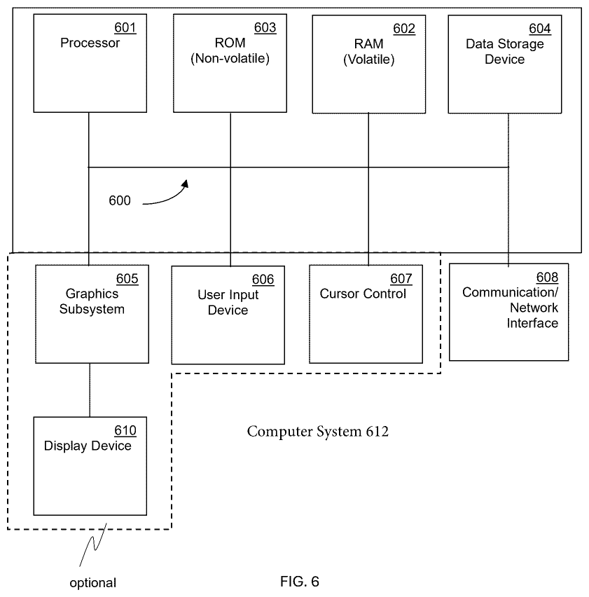

In ground station 27, Data Analytics module 272 software executes on High Performance Computer 273 which typically includes a processor, memory, and network communication components (e.g., computer system 612 of FIG. 6).

The RPIC may directly control the flight path of a designated lead drone, while the remaining drones in the squadron maintain autonomous formation relative to the leader. Formation types, such as a flying-V, diagonally staggered echelon, orbital, etc. can be dynamically adjusted based on mission objectives and site geometry. These formations support synchronized data capture for 3D scanning, volumetric analysis, and surface modeling. In certain embodiments, hive flight in-formation is tightly synchronized, enabling the entire formation to behave as a cohesive, rigid structure maneuvering at six degrees of freedom and at airspeeds exceeding 20 mph. This coordination maximizes imaging redundancy, data precision, safety, operating efficacy, and return on investment.

FIG. 3 depicts an exemplary Airborne Control Tower UAV system 300 for Beyond Visual Line of Sight (BVLOS) drone flight according to embodiments of the present invention. In the embodiment of FIG. 3, a single UAV 311 orbits around a stationary ground point 315 (see radius 316 of ground perimeter 314) and streams video to be displayed for the RPIC 326 at the ground station 328 in a similar fashion to how radar is used for air traffic control in the vicinity of an airport to provide control tower functionality (e.g., to produce visual data showing other drones in the vicinity. This can be achieved by the drone 311 flying in a substantially circular pattern around designated point 315 while its camera 312 is pointed towards the center of the orbit. The video stream provides a real-time aerial view of several UAVs flying as squadron(s) 313, as well as other airspace users in the area surrounding the designated inspection area.

According to some embodiments, human intervention is involved in the decision-making process to enhance the safety of the squadrons inspection operations. For example, a team including the RPIC and optionally visual observer(s) can operate several UAVs per squadron. High resolution (e.g., 4K video) displays mounted in portable Ground Station 328 render real-time visual data that enable the pilots to visually monitor the air traffic of their airborne multi-UAV operations, as well as other airspace users in the vicinity. Advantageously, this unique feature provides sufficient visual information to meet the requirements of the FAA BVLOS waiver approval process.

In the exemplary embodiment of FIG. 3, system 300 includes Orbiting Tower UAV 3D view of the display Module 31, as well as the same Orbiting Tower UAV Top-Down View of the Module 32 (two differently depicted displays of the same orbiting Control Tower UAV). Module 311 includes the clockwise Orbiting Tower UAV and Module 312 representing the down-pointing video camera as the UAV payload. The UAV orbits around Module 315 which represents a clearly visible ground Real Time Kinematic (RTK) reference point. Modules 316 and 324 represent the Current real-time UAV/video camera attitude. Modules 313 and 323 represent the lead UAV of a five UAVs squadron that is on inspection mission of Modules 314 and 321 represent the Large-Scale-Solar (LSS) utility-PV plant under inspection at ground level in the background.

Module 322 represents the telemetry information box of the lead UAV of a five UAVs squadron, including Augmented Reality superimposed on the Orbiting Tower UAV video feed to indicate geolocation coordinates (38° N, 122° W), altitude (75′ agl), ground speed (26mph), and heading azimuth (126° Az), for example. Orbiting Tower UAV Module 311 includes video feed from video camera 312 showing the entire 3D volume view continuously rotating in direction 324 and 316 Azimuth and around the ground RTK 315. Module 326 represents the FAA Part 107 certified RPIC who is typically the top authority of the mission. Visual Observer Module 327 represents a person designated to assist the RPIC as an optional resource that provides situational awareness.

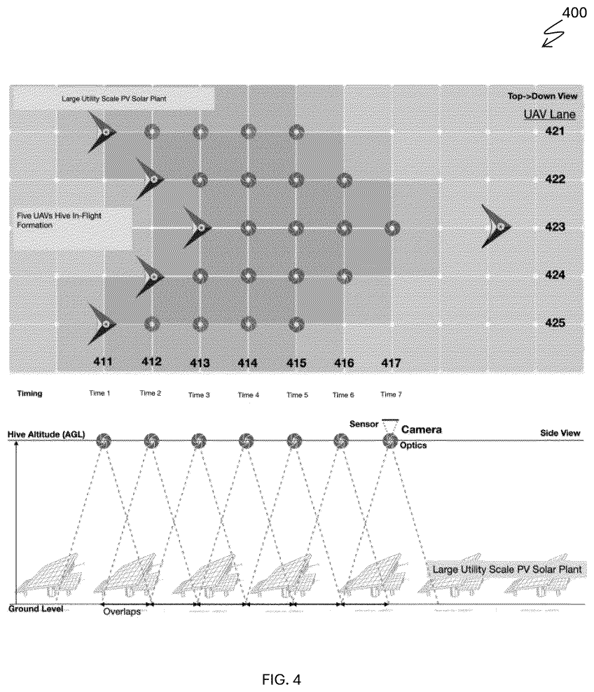

The top portion of FIG. 4 shows a top-down view of a five UAVs hive (also known as a squadron or fleet) inspecting a large-utility scale PV solar plant at a designated inspection area. The five UAVs are shown synchronously flying from left to right over five UAV Lanes 421, 422, 423, 424, and 425. As the 5 UAVs with their camera payloads (depicted as circular shutter) fly at the speed of 20mph, they take snapshots at every time as marked by time markers 411, 412, 413, 414, 415, 416, and 417 depicted in FIG. 4 while maintaining a-stable in-flight formation as practically possible. The 4 square quadrants around each snapshot location show the approximate ground square footprint (field of view) covered by each snapshot. It is noted that the quadrants between Lane 421 and Lane 422 and between snapshots 412 and 415 are shaded darker to indicate that four cameras operate at slightly different field of view (FOV) angles and can take snapshots simultaneously, according to embodiments. The camera data is collected with these multiple redundant photos by 4 slightly different FOV cameras (e.g., 4× redundancy) in a single pass of five UAVs. In comparison, a single drone scan would require 12 passes at 80% overlap and sidelap between passes over the same PV solar strip size with lower quality and 80% redundancy (compare to 400% redundancy the hive provides in a single pass). The overlapping images captured by the drones enable 3D reconstruction (a.k. a Digital Twin) of the solar panels at the base station.

The bottom portion of FIG. 4 shows a side view of the field of view of each camera showing the optics (lens) and the focal length of the sensor. All UAVs can be configured to fly at substantially the same altitude above ground level. The square pyramid depicted between the lens and the ground defines the boundaries (field of view) of the square snapshot captured by the drone sensor. Importantly, by changing the altitude of the UAVs, images of various resolutions can be captured. In general, flying the UAVs lower to the ground yields higher resolution images but requires additional passes to capture required mission data. Importantly, the 80% overlap/sidelap depicted in FIG. 4 is an example of the capabilities of a single drone for providing redundancy by progressing the 20% for each overlap which translates to 5 overlapping snapshots, where each snapshot progresses by 20%. Moreover, the hive of 5 drones accomplishes overlap/sidelap using several cameras around a time (x) within a lane (y). In some such quadrants, multiple cameras (e.g., 2 or more) of different drones capture image in near real-time including approximately 50% overlap using several hundred images in a single pass, compared to a single drone that requires 5 passes for lower redundancy.

Another critical claim is the flexibility in planning the mission, including the number of UAVs, their formation, distance to surface, their speed and the desired Ground Sample Distance (GSD) a.k.a. resolution and the desired redundancy. This flexibility is key in optimizing the operations by continuous improvement: a Lean or Agile process which has limitless optimization potential.

While the description above is mainly focused on the applications of autonomous UAV visual inspection for large-scale utility solar farms and the like, embodiments of the present invention are well-suited to perform a variety of coordinated tasks efficiently over wide areas. This functionality is particularly valuable in both governmental and commercial sectors. Examples of these sectors include large-scale delivery using synchronized drone fleets for delivering goods across urban and rural areas. By implementing embodiments of the UAV control and communication technology described herein, such fleets can optimize routes and schedules in real-time, reducing delivery times and costs.

The field of Construction Site Management can be enhanced by deploying coordinated drone fleets to perform real-time monitoring of large construction sites per engineering blueprint, providing project managers with the data needed to track progress, manage resources, and ensure compliance with safety standards.

Precision Agriculture can deploy drone fleets described herein to perform synchronized tasks like seeding, spraying pesticides or fertilizers, and gathering crop data, which helps in maximizing crop yields and reducing resource wastage.

Embodiments of the present invention are well-suited to Renewable Energy Maintenance. For example, UAVs can be used for solar panel and wind turbine installations, Distributed Energy Resources connected to the nation's grid, where cables, inverters, battery storage and other such assets are also inspected routinely to confirm sustainable energy quality, where synchronized drones can inspect and maintain vast fields of PV panels or wind turbines efficiently, applying predictive maintenance, enabling planned maintenance and reducing downtime.

In the telecommunications industry, synchronized drone fleets can be used to inspect and maintain cell towers and other telecommunications infrastructure across large areas, ensuring consistent service quality and quicker maintenance responses.

Finally, in the entertainment industry, drone fleets can be used to create complex aerial shots and panoramas that would be impossible or prohibitively expensive to capture with traditional filming equipment. The uses described above can be performed according to the embodiment described herein for controlling UAVs, charging UAVs, and accessing data acquired by fleets of UAVs during flight.

Other potential applications of embodiments of the present invention include Agrivoltaic sites, where drones can facilitate the management of integrated agriculture and photovoltaic systems to maximize land use and energy output. Community Solar Microgrid Roofs can use drones to assist in the installation and maintenance of community solar projects, ensuring consistent power supply and efficiency. Utility-Solar and Storage (e.g., batteries) can use synchronized drones to monitor and manage solar and storage facilities, enhancing efficiency and response to grid demands. Wind Turbine Power Plants can use drones to perform synchronized inspections across wind farms, improving maintenance and operational efficiency. Furthermore, large Infrastructure Construction can use synchronized drone fleets to aid in the planning and real-time monitoring of major construction projects, ensuring greater precision and safety.

FIG. 5 is a flowchart depicting the steps of an exemplary computer-implemented process 500 for capturing images to perform a visual inspection of a large-scale facility, such as a utility-solar farm or the like (e.g., wind farms, large scale military facilities, geothermal sites, construction sites, etc.). Process 500 performs using airborne squadron of UAVs 51 flying in synchronized formation with one UAV designated as a squadron leader, that can be controlled by a RPIC for image capture purposes.

As described in greater detail above, the UAVs include communication equipment (e.g., wireless radios) for communicating with other UAVs and/or for communicating with the portable ground station 52. Typically the UAVs communicate over a mesh network hosted by the UAVs, although 5G, satellite communication, and other means of wireless communication can be used according to embodiments. It is noted that the steps 511, 512, 513 and 514 depicted above bus 510 are substantially performed by airborne squadron 51, and steps 521, 522, 523, 524, 525, and 526 are substantially performed by ground station 52. Some of these steps involve communication between squadron 51 and ground station 52 over wireless bus 510. Communications between UAVs of squadron 51 and ground station 52 can include telemetry data, such as geolocation data, speed data, acceleration data, and GPS coordinates of any UAV in the area under inspection to enhance situational awareness and operational control.

Step 521 is the continuous improvement mission planning phase for inspection of a large-scale facility. This step also functions to incorporate mission retrospective feedback which will be addressed below in more details. Step 522 includes generating a squadron design for inspection of a particular facility, and the squadron design can include the number of UAVs deployed at the same time, the number of separate UAV squadrons, designation of the lead UAV(s), designation of control tower UAV(s), designation of in-flight formation, battery and recharging configuration, etc. The initial mission planning can include visual and GPS-based local flight plan for the designated site to be inspected, and the plan can be modified according to weather forecast information or real-time weather data. For example, the number of drones used to perform inspection can be calculated such that each drone can fully perform its role using a single battery without recharging or swapping batteries. The mission planning can also include a plan for a mesh wireless network, configuring mesh rider modules.

The mission planning can be adjusted according to any notices filed with an aviation authority to alert aircraft pilots of potential hazards along a flight route (e.g., a Notice to Air Men (NOTAM)) or any air traffic control (ATC) communication relevant to the mission. According to some embodiments, any mission backlog can be prioritized in module 514 to complete data acquisition that was previously performed and requires re-capturing some of the image data, for example.

At steps 511, 514 and 512, the UAV of squadron 51 are flown in formation over the inspection area and capture images for 2D mapping and/or 3D scanning and transmit them to the ground station via a Platform Wireless Bus 510 to step 523. The quality feedback AI Machine Learning loop consists of steps 514, 512, 523 and back to 514 delivers each image to be tested for single image artifacts (e.g. smudged, blurred) but also for stitching quality test by the photogrammetry SW. At mission initialization, obviously a minimal number of images must accumulate in the AI Machine Leaning loop for the stitching quality test to pass, while there is not enough images to be stitched to each other, thereby module 512 can confirm image quality and pass them to its “Yes” output and into module 513 for customer final mission report document generation ensuring real-time high quality data generation. Any initial on-site inspection backlog can be executed and data quality corrections can be performed by UAVs of airborne squadron 51. Process 500 can proceed directly to module 513 and then to Mission Retrospective 525 when there are no data quality corrections queued.

At step 523, the data (e.g., image data) previously captured is processed and/or analyzed using a computer system (e.g., computer system 272 of FIG. 2) at ground station 52. Step 523 can be performed substantially in real-time using new images produced in a Sprint Backlog execution in step 511, passed through to step 514 and prioritizing them with Recapture Backlog images. Image flow, prioritization algorithms and image quality decision-making can include executing photogrammetry software to detect errors, flaws, glitches, artifacts, etc. Stitching together overlapping 2D images can be performed to create a 3D representation of the inspection site.

After the individual images are stitched together or otherwise manipulated, adjusted, or altered, these results are passed to step 512 with a decision element of YES/NO indicating if additional snapshot images should be taken to improve the results. Decision element 512 can be set to any level of image quality to be satisfied. For example, according to some embodiments, step 512 is satisfied when 99% of images pass the image quality threshold. According to other embodiments, the threshold is 99.9% or 99.999%, for three nines precision or, five nines precision, respectively, for example. The threshold of decision element 512 can also be determined according to other variables, such as battery life, mission time, etc.

Process 500 proceeds in a looping manner as depicted in steps 511, 514, 512 and 523 according to the Near-Real-Time Agile Backlog Prioritization, Machine Learning (AI) Feedback Loop, until the identified flaws are removed, the high quality data is used to produce the Customer Final Mission Report in step 513, or the process times out (e.g., after a predetermined threshold time or number of attempts).

At step 512, data quality assessment is performed at ground station 52. If an image fails to meet quality standards, the image can be automatically flagged and queued for re-capture. According to some embodiments, instead of immediately performing image re-capture, flagged images can be accumulated in a queue for re-capture at a later time. This allows the UAV to continue capturing new images without interruption which increases the effectiveness of the 3D scanning/imaging process. If the captured data does not pass the data quality assessment performed in steps 523 and 512, process 500 performs real-time machine learning on the deficient data and returns to step 514 (Backlog Prioritization that is part of AI algorithm) to capture new data to correct the deficiencies of the existing data. Once the data quality assessment of step 512 is passed, process 500 proceeds to step 513.

According to some embodiments, image re-capture is performed dynamically according using AI to determine when a drone should re-capture a particular image based on the mission plan, backlog status, current position of the squadron, speed, battery life, current weather, predicted future weather, etc., so that image re-capture is performed efficiently without disrupting or causing delays to the overall mission plan. For example, in most cases, the squadron should not travel from one end of the mission site to the other end to re-capture a single image when there are other images that need to be taken that are closer to the current position of the squadron. On the other hand, if the squadron is already traveling over a portion of the site than requires recapture, AI can instruct the squadron to re-capture the image when they are in an appropriate or convenient position to do so.

At step 513, the 3D digital twin representing the site under inspection is completed and visual inspection is performed by squadron 51 according to the digital twin and the mission planning details generated in steps 521 and 523. During step 513, high quality visual data is captured by squadron 51 for visual inspection purposes, and any potential issues at the facility can be automatically identified.

According to some embodiments, overlapping images are taken by multiple drones simultaneously and transmitted to the ground station for stitching together to create a 3D digital twin. The images can be processed as depicted in FIG. 2 using software 272 executed by computer 273 at the ground station 52 in FIG. 5, for example. According to some embodiments, an O&M report is automatically generated and contains the findings of process 500 step 513, such as the inspection details, detected issues, detailed images, predictive maintenance report, Final Mission Report etc.

Importantly, any low-quality or otherwise deficient (e.g., blurry or corrupt) image data identified by the data quality assessment of step 512 can be analyzed by artificial intelligence (e.g., machine learning algorithms, neural networks, Large Language Models, etc.) to determine adjustments that can be made to improve future image capture data. The adjustments can be specific to a facility, to a drone model, to a sensor model, etc. In this way, the quality and efficiency of process 500 can be improved continuously as new data is captured and analyzed, including captured image data, telemetry data, weather data, sensor data, etc. Similarly, after the completion of the mission objectives at step 513, a mission retrospective analysis is performed at step 525 to generate long-term predictive maintenance dataset that can be used to improve the quality of the image capture data for inspection purposes (e.g., identifying potential defects or other issues).

The analysis performed in step 525 generates global feedback 526 that can be stored and used to accumulate data from different missions or different passes of the same mission. As depicted in FIG. 5, the accumulated global feedback data 526 is provided to mission planning step 521 to improve the quality and efficiency of future mission planning of that specific site.

According to some embodiments, re-capture of image data is performed immediately prior to the completion of the mission. Under this approach, UAV squadron 51 processes the queue, revisiting specific locations to re-capture certain data (e.g., the images identified in the quality assessment performed in step 512). This approach minimizes disruptions during the initial scanning phase and ensures all images meet quality standards without extending the mission duration unnecessarily.

Once the long-term predictive maintenance datasets 526 are updated to include retrospective feedback from the mission at the ground station 52, the datasets 526 can be transmitted over the Internet (e.g., using cloud storage) to update prioritized global mission backlog 531 and for planning the next mission 532. Prioritized global mission backlog 531 can include an automatic UAV-Hive preflight checklist, the weather forecast for a particular site (e.g., solar plant), and data from prior missions and retrospectives.

As described above, one advantage of the present invention is that components can be upgraded without extensive system redesign. For example, the mesh network and built in APIs are replaceable and can continue to communicate via the Mesh Wireless Bus with only a few software updates to the APIs. Moreover, a Real Time (or near real-time) data analysis feedback loop can be executed so that each image is quality-tested in near real-time by the ground station, leveraging local high performance HiveOS data analytics capabilities to enable responsive continuous operational improvement via image recapture as needed to be executed before the mission ends.

According to some embodiments, automated feedback of pattern recognition and deviations from expected performance are detected automatically and can be used proactively to adjust future operations by updating the algorithms and using predictive models to improve mission accuracy and responsiveness. The feedback pattern can be used to configure all future mission operations, globally, or to configure specific sites, regions etc.

The autonomous platform described herein can be operated by a certified FAA BVLOS single RPIC, authorized to operate plurality of UAVs. The platform is highly scalable, flexible and effective, and can employ a distributed battery concept that does not require swapping of batteries. The drones can fly autonomously to complete missions of UAVs in-flight formation as a squadron (a.k.a. hive), and can be piloted in accordance with FAA Part 107 Beyond Visual Line of Sight (BVLOS) Waiver Requirement, that certifies a single RPIC to simultaneously operate multiple drones for imaging and inspection. (§ 107.35 Operation of multiple small, unmanned aircraft-A person may not manipulate flight controls or act as a RPIC or visual observer in the operation of more than one unmanned aircraft at the same time.)

### Exemplary Computer System

Embodiments of the present invention are drawn to drones and ground stations for communicating with and controlling said drones to perform large-scale visual inspection and data capture operations. The following discussion describes one such exemplary electronic system or computer system that can be used as a platform for implementing embodiments of the present invention. For example, computer system 612 can be part of a portable ground station deployed at the inspection site for coordinating drone activity and storing/processing image or video data captured by the drones (e.g., system 273 of FIG. 2).

In the example of FIG. 6, the exemplary computer system 612 includes a central processing unit (CPU) 601 for running software applications (e.g., software 272 depicted in FIG. 2) and optionally an operating system. Random access memory 602 and read-only memory 603 store applications and data for use by the CPU 601. Data storage device 604 provides non-volatile storage for applications and data and may include fixed disk drives, removable disk drives, flash memory devices, and CD-ROM, DVD-ROM or other optical storage devices. The optional user inputs 606 and 607 comprise devices that communicate inputs from one or more users to the computer system 612 (e.g., mice, joysticks, cameras, goggles (e.g. Apple Vision Pro), touch screens, and/or microphones).

A communication or network interface 608 includes a plurality of transceivers and allows the computer system 612 to communicate with other computer systems, networks, or devices via an electronic communications network, including wired and/or wireless communication and including an Intranet or the Internet (e.g., IEEE 802.11 wireless standard). The communication or network interface 608 can communicate over a mesh wireless network and can operate multiple transceivers simultaneously, according to some embodiments.

The optional display device 610 may be any device capable of displaying visual information in response to a signal from the computer system 612 and may include a flat panel touch sensitive display, or goggles such as Apple Vision Pro, for example. The components of the computer system 612, including the CPU 601, memory 602/603, data storage 604, user input devices 606, and graphics subsystem 605 may be coupled via one or more data buses 600.

According to some embodiments, graphics subsystem 605 includes one or more graphical processing units (GPUs), such as an ATI or Nvidia GPU (e.g., a GeForce RTX 4080 or the like). Multiple GPUs can be organized in an array or cluster of GPUs for improved parallel processing. The GPUs of graphics subsystem 605 can be used to perform any of the image processing steps described above according to embodiments, and/or to execute or train AI algorithms for image processing, flight management, mission planning, or the like.

Accordingly, embodiments of the present invention provide a means of predictive maintenance that maximize uptimes, improves reliability, and enhances productivity by reducing the number of unplanned breakdowns. Advantageously, the embodiments described herein further reduce operational costs by performing pre-planned maintenance tasks before a sudden and impactful failure occurs and become hazardous, costly, labor, and time intensive.

Embodiments of the present invention are thus described. While the present invention has been described in particular embodiments, it should be appreciated that the present invention should not be construed as limited by such embodiments but rather construed according to the following claims.

What is claimed is:

1. A robotic equipment inspection system, comprising:
a plurality of unmanned aerial vehicles (UAVs) comprising a plurality of sensors and operable to fly in coordination to capture data using the plurality of sensors; and
a wireless control system operable to manage coordinated flight of the plurality of UAVs via a mesh communication network providing real-time communication amongst the UAVs themselves and with a ground station, wherein the ground station comprises:
a memory operable to store data captured by the plurality of sensors of the plurality of UAVs; and
a processor operable to analyze the data captured to identify ground-based equipment suspected of requiring maintenance.

2. The robotic equipment inspection system of claim 1, wherein the processor is further operable to:
generate a 3D digital representation of the equipment for inspection; and
generate a flight plan for the plurality of UAVs based on the 3D digital representation.

3. The robotic equipment inspection system of claim 1, wherein the plurality of UAVs are capable of: automatic collision avoidance; follow-the-leader flying;
automatic take-off and landing; automatic return to base for charging; and automatic image capture operations.

4. The robotic equipment inspection system of claim 1, wherein at least one of the plurality of UAVs is designated as a control tower UAV operable to provide substantially real-time video data to a remote pilot at the ground station, wherein at least one of the plurality of UAVs is designated as squadron leader, and wherein other UAVs of the plurality of UAVs fly substantially in synchronization with a flight path of the squadron leader.

5. The robotic equipment inspection system of claim 4, wherein the control tower UAV transmits the video data directly to the ground station using a separate wireless network.

6. The robotic equipment inspection system of claim 4, wherein the first UAV is operable to transmit sensor data to a second UAV of the plurality of UAVs, and wherein the second UAV is operable to forward the sensor data to the remote pilot.

7. The robotic equipment inspection system of claim 4, wherein the video data comprises 30 frames per second video data.

8. The robotic equipment inspection system of claim 1, wherein the ground-based equipment comprises Photovoltaic (PV) panels, and wherein the plurality of UAVs comprise a plurality of infrared (IR) sensors operable to detect temperature variations in the PV panels to identify potentially malfunctioning cells of the PV panels.

9. The robotic equipment inspection system of claim 1, wherein the data captured comprises image data, wherein the processor is further operable to analyze the image data to identify image artifacts, and wherein the wireless control system causes the plurality of UAVs to recapture images responsive to the identifying image artifacts.

10. The robotic equipment inspection system of claim 1, wherein the wireless control system is operable to receive input from a remote pilot to control the plurality of UAVs in real-time.

11. The robotic equipment inspection system of claim 1, wherein the wireless control system is operable to control the plurality of UAVs according to a predetermined flight path and formation.

12. A method for inspecting ground-based equipment using airborne robotics, comprising:
deploying a plurality of unmanned aerial vehicles (UAVs) over a designated inspection area, wherein the plurality of UAVs comprise a plurality of sensors;
capturing image data of ground-based equipment using the plurality of sensors;
transmitting captured image data to a ground station via a mesh wireless communication network;
processing the image data at the ground station to create a 3D digital representation of the ground-based equipment; and
performing detailed imaging of the ground-based equipment according to the 3D digital representation to identify a potential defect in the ground-based equipment.

13. The method of claim 12, wherein a first UAV of the plurality of UAVs is a control tower UAV, wherein a second UAV of the plurality of UAVs is a squadron leader, wherein other UAVs of the plurality of UAVs fly substantially in synchronization with the squadron leader, and wherein the squadron leader and the other UAVs fly in view of a camera of the control tower UAV.

14. The method of claim 12, further comprising:
automatically analyzing results of the detailed imaging to confirm the potential defect in the ground-based equipment; and
generating a maintenance report comprising the defect of the ground-based equipment.

15. The method of claim 12, further comprising automatically adjusting flight paths of the UAVs based on real-time weather data.

16. The method of claim 12, further comprising:
receiving battery data from the plurality of UAVs; and
adjusting a flight path of the plurality of UAVs based on the battery data.

17. The method of claim 12, further comprising:
identifying an image artifact in the captured image data; and
recapturing images until the image data is substantially free of image artifacts.

18. A ground station for coordinating unmanned arial vehicle (UAV) flight and visual inspection of ground-based equipment, the ground station comprising:
a wireless communication network operable to receive real-time data from a plurality of unmanned aerial vehicles (UAVs) over a mesh network;
a processing module operable to generate image analysis results by analyzing the received data to identify potential defects in the ground-based equipment;
a control module operable to adjust the flight paths of the UAVs based on the image analysis results via the wireless communication network; and
memory operable to store the real-time data and image analysis results.

19. The ground station of claim 18, wherein the processing module if further operable to:
identify image artifacts in the received data; and
instruct the plurality of UAVs to re-capture additional data via the wireless communication network until the additional data is sufficiently free of image artifacts.

20. The ground station of claim 18, wherein the processing module is further operable to simulate a 3D environment based on the captured data, wherein a flight plan of the plurality of UAVs is simulated within the 3D environment, wherein the flight plan is adjusted based on the simulated flight plan, and wherein the flight plan comprises at least one of: a number of UAVs; a type of UAV; a UAV recharging schedule; a UAV formation; and a UAV flight altitude.

21. A method of imaging ground-based equipment using airborne robotics to produce a 3D model, the method comprising:
flying a squadron of unmanned aerial vehicles (UAVs) over the ground-based equipment, wherein the squadron automatically flies in synchronized formation with a squadron leader UAV;
capturing image data of ground-based equipment using cameras disposed on the squadron of UAVs, wherein the image data of respective UAVs of the squadron comprise overlapping image data; and
generating a 3D representation of the ground-based equipment based on the overlapping image data.

22. The method of claim 21, wherein the squadron leader is controlled remotely by a remote pilot in command.

23. The method of claim 22, further comprising flying a control tower UAV comprising a camera orbiting around a designated point, wherein the squadron of UAVs are visible to the camera of the control tower UAV to enable beyond visual line of sight (BVOS) flight of the squadron leader by the remote pilot in command.

24. The method of claim 21, wherein the overlapping image data comprises at least 50% overlapping image data.

25. The method of claim 21, wherein the overlapping image data comprises at least 80% overlapping image data.
